(19) United States
(12) Patent Application Publication
(10) Pub. No.: US 2009/0206516 A1
(43) Pub. Date: Aug. 20, 2009

(54) METHOD OF MAKING INTEGRATED PLASTIC PART

(76) Inventors: Ingmar Petersen, Esslingen (DE); Bernd Schwarz, Waldorfhaslach (DE); Markus Pfletschinger, Eningen (DE)

Correspondence Address: K.F. ROSS P.C., 5683 RIVERDALE AVENUE, SUITE 203 BOX 900, BRONX, NY, 10471-0900, US

(21) Appl. No.: 12/430,350

(22) Filed: Apr. 27, 2009

Related U.S. Application Data
(63) Continuation of application No. 11/605,195, filed on Nov. 28, 2006, now abandoned.

(30) Foreign Application Priority Data
Nov. 30, 2005 (DE) 102005057026.7

(51) Int. Cl. B29C 45/14

(52) U.S. Cl. 264/259

(57) ABSTRACT

A motor-vehicle part is made by hot-pressing to the part a substrate comprising a layer of nonconductive material carrying a conductive structure so as to fix the substrate to the part such that the conductive structure forms a surface of the part.

### CROSS REFERENCE TO RELATED APPLICATION

This application is a continuation of copending application Ser. No. 11/605,195 filed 28 Nov. 2006 with a claim to the priority of German patent application 10 2005 057026.7 filed 30 Nov. 2005, whose entire disclosure is herewith incorporated by reference.

### FIELD OF THE INVENTION

The present invention relates to a vehicle part made of electrically nonconductive material.

### BACKGROUND OF THE INVENTION

It is basically known to make vehicle parts of electrically nonconductive material, such as plastic. Plastic vehicle parts of this type have the advantage that they offer very high design freedom, have low weight and are easy to make.

In addition, automobile manufacturers want to integrate electrically conductive structures (a substrate incompatible with UP imprinted with a compatible conductive paste (resinous basis of the paste)) on or in these plastic vehicle parts in order to make, for example, antenna structures for vehicle antennas. In addition to these conductive structures in or on the vehicle part and serving as antenna structures, it is also possible to implement electrically conductive regions for signal transmission and/or power supply. Also power can be supplied this way.

### OBJECT OF THE INVENTION

It is therefore the object of the invention to improve a vehicle part made of electrically nonconductive material, particularly a plastic material, such that integration and/or attachment of electrically conductive structures in the vehicle part is improved for the desired applications, particularly that the above-described disadvantages are avoided and the vehicle part as well as the electrically conductive structures can be made with the precision and shape required for the particular application.

Another object is to provide an improved method of making such a part.

### SUMMARY AND DESCRIPTION OF THE INVENTION

According to the invention, a substrate that is made of electrically nonconductive material and comprises an electrically conductive structure is attached to the vehicle part, the substrate being attached to the vehicle part by means of a hot-press method. The vehicle part as such is made of a plastic material, SMC (Sheet Molding Compound, also referred to as a resin impregnated glass mat or prepreg) or BMC materials being particularly essential and advantageous for the invention. The advantage is that a plastic part produced using a hot-press method is pressed together with a resin-impregnated paper or film during forming. Prior to that, the desired structure was applied to this substrate in the form of conductive silver paste, for example, using a printing method.

By way of example, the incorporation of paper imprinted with silver and impregnated with melamine resin in the SMC (sheet molding compound) molding method will be mentioned here. As a result of the compression force and the temperature in the tool, the materials are pressed together. Furthermore, this method results in a favorable volume reduction of the traces and hence to higher conductance values. Following demolding, the traces are located on the surface or under a thin resin layer, depending on how the substrate is oriented. It is also possible to place the substrate in advance between the cut UP (unsaturated polyester resin) resin mats. Here as well the traces would be internal.

The material, however, does not have to be available in the form of cut-to-size pieces (resin mats/prepregs). It is also possible to press it together with a mixture, as is the case with BMC (bulk molding compound).

In a further embodiment of the invention, the substrate is a plastic film and therefore flexible to work with and can be adapted to the outside contours and the dimensions of the vehicle part. In addition, working with such a plastic film during the production method, meaning when pressing it together with the vehicle part, is easier than with a rigid substrate. Furthermore, however, rigid substrates such as printed circuit boards may also be used, employed particularly when the vehicle part as such is made planar at least in part.

SMC is a molding compound on the basis of glass fiber-reinforced UP resins. It is a thermosetting material. According to DIN 16913, five different SMC types have been standardized. In addition, a large number of nonstandardized SMC compositions are available, tailored to the respective application.

Application examples for SMC include the following (this list is not exhaustive): passenger car and truck production: engine hoods, trunk covers, cylinder head covers, noise encapsulation in the engine compartment and exhaust regions, tractor roofs, spoilers, parts for interior and exterior molding and the like.

BMC is available as a shapeless, doughy mass. It is processed like SMC using hot-press technology. BMC is at times also used in the injection molding technology. SMC is likewise produced from all conventional thermoset matrix systems.

Application examples for BMC include the following (this list is not exhaustive): reflectors, cylinder head covers, service switch cabinets, line safety (LS) switches, end plates, fuse strips, insulators, appliances and the like.

The advantages of SMC and BMC are that they have similar coefficients of expansion to steel, a high attenuation factor, recyclability, particularly their density results in weight advantages compared to steel, lower tooling costs, Class A surface possible, temperature stability, fire resistance, corrosion resistance, design freedom, high machine output and short processing times. In addition, they can be painted. It is therefore possible to paint over the embedded coated and/or press-molded conductive structure, which offers an additional protective function and also design advantages.

The structures are advantageously produced using a screen-printing method by printing conductive pastes. Furthermore, the substrate may or should comprise indentations and/or cutouts and/or markings. This simplifies the introduction, positioning and stabilizing of the substrate in the tool and/or optimizes the surface available for the substrate.

Alternatively, the substrate may be removed. To do so, the film (a substrate incompatible with the UP comprising a compatible conductive paste (resinous basis of the paste)) is imprinted, placed in the tool and the electrically conductive structure is aligned with the SMC/BMC. Depending on the method, the film can be removed, with the structures then having been transferred into/onto the SMC/BMC. In this case, coordination of the materials used is required.

So as to allow possible outgassing, the substrate may comprise partial cutouts. These may be filled with SMC/BMC (“squeezed”) during in-mold coating. In this case, the SMC will be located on the surface of the resultant vehicle part and allows outgassing. Mechanical joining is also possible this way

We claim:

1. A method of making a motor-vehicle part comprising the step of:
hot-pressing to the part a substrate comprising a layer of nonconductive material carrying a conductive structure so as to fix the substrate to the part such that the conductive structure forms a surface of the part.

2. The method defined in claim 1 wherein the substrate is hot-pressed to the part such that substrate is unitarily bonded with the motor-vehicle part and the electrically conductive structure is in or on the surface of the motor-vehicle part.

3. The method defined in claim 1 wherein the substrate is unitarily bonded with the motor vehicle part such that the electrically conductive structure lies under the surface.

4. The method defined in claim 1, further comprising the step of
providing the substrate with partial cutouts that facilitate outgassing of the motor-vehicle part.

5. The method defined in claim 1 wherein the substrate is a plastic foil impregnated with a resin.

6. The method defined in claim 1, further comprising
separating the substrate during the pressing from the surface of the part.

7. The method defined in claim 1, further comprising the step after hot-pressing of
separating the substrate from the surface of the part.

8. The method defined in claim 1, further comprising the step of
separating the substrate during the hot-pressing from the part with wherein the substrate is separated during the pressing with an agent that is impervious to a parting compound.

9. The method defined in claim 1 wherein the hot-pressing is SMC and/or BMC.
